(19) United States
(12) Patent Application Publication
(10) Pub. No.: US 2006/0200366 A1
(43) Pub. Date: Sep. 7, 2006

(54) System of management of health-care resources

(76) Inventor: Anuthep Benja-Athon, New York, NY (US)

Correspondence Address: ANUTHEP BENJA-ATHON, 210 E 36TH ST., GR FLOOR, NEW YORK, NY, 10016, US

(21) Appl. No.: 11/074,236

(22) Filed: Mar. 7, 2005

(51) Int. Cl. G06Q 10/00; G06Q 99/00

(52) U.S. Cl. 705/2; 705/50

(57) ABSTRACT

An electronic system of management the health-care resources by the health-care consumers, health-care buyers and physicians. It effects the appropriate payments to physicians for the health-care services rendered by the physicians by allowing the sharing, using and analyzing digital information including certain denominators being provided, used and generated by individual patients and physicians.

This is application is a continuation-in-part of application attorney docket ABA0205 entitled the Consumers-Buyers-Physicians Health-care filed Feb. 16, 2005 which is pending

### FIELD OF INVENTION

An electronic system of management of health-care resources.

### BACKGROUND OF THE INVENTION

A pending application attorney docket ABA0205 entitled the Consumers-Buyers-Physicians Health-care filed Feb. 16, 2005, a pending application Ser. No. 11/022,410 filed Dec. 27, 2004 entitled the Consumers-Buyers-Physicians Health-care, a pending application Ser. No. 10/950,315 entitled a Method of Empowering Consumers-Controlled Health-Care filed Sep. 27, 2004, a pending application Ser. No. 10/760,694 entitled a method of Modulating Health-Care expenses filed Jan. 21, 2004, a pending application Ser. No. 10/328,993 entitled the Best American Healthcare System filed Dec. 26, 2002, and an abandoned application Ser. No. 10/298,100 entitled the Best Healthcare System filed Nov. 18, 2002 and U.S. Pat. No. 6,132,218 entitled Images for Communication of Medical Information in Computer was granted to this applicant on Oct. 17, 2000 represent our continual quests to solve the current health-care crisis.

Never before in the history of health-care in America—or for this matter in the world—the present invention—together with the pending and patent supra—provides the best health-care system human civilization has ever had.

The current or prior art systems of health-care are primitive at best, the health-care services are business and commodities and are treated as such, and all parties in these systems are adversarial. The current or prior art systems of health-care are inefficient and they stress, degrade and devalue the quality of health-care and the quality of life of patients and physicians.

The present invention is to provide the best system of management of the health-care resources.

Specifically, the present invention is to provide the best means for using the health-care money.

More specifically, the present invention is the best means for directing the health-care money to appropriately pay or compensate the physicians and other health-care providers for the best or optimal medical and surgical services.

Furthermore, the present invention can significantly reduce billions of dollars of waste and frauds each year in health-care which cannot be heretofore achieved by the current or prior art health-care system. In other words, the present invention—together with the pending and patent supra—is the only means for solving the current health-care crisis in America.

### SUMMARY OF THE INVENTION

The current and prior art health-care systems are incompatible with the standard and quality of life of the American society. These systems cause harm to and corrupt the American people including physicians and other health-care providers.

The best system ahead of the above current and prior art health-care systems is embodied by the present invention together with the pending applications and patent supra. The present invention provides an electronic system of management and direction of the health-care resources by the health-care consumers, health-care buyers and physicians. It eliminates inefficiencies and effects the appropriate payments to physicians for the health-care services rendered by the physicians by allowing the sharing, using and analyzing of digital information including certain denominators being provided, used and generated by individual patients and physicians among health-care consumers, health-care buyers and physicians.

### DESCRIPTION OF THE PREFERRED EMBODIMENTS

The present invention is a system of management the health-care resources. More specifically, the present invention is a system of electronic management of the health-care dollars by the health-care consumers, health-care buyers such as, but not limited to, companies, corporations, organizations and government who pay for the health-care services, physicians and other health-care providers who provide health-care services to said health-care consumers or who provide health-care services to said consumers on the behalf of said buyers.

The present invention provides a system of electronic transactions effecting payments to physicians for the health-care services rendered by said physicians comprises share and cooperative efforts of health-care consumers or patients and physicians. The common currency in this system is the information being provided or generated by individual patients and, consequently, individual physician, physicians or other health-care providers (henceforth collectively known as physician or physicians).

The electronic or digital information comprises a first digital data generated by a patient and, consequently, a second digital data generated by a physician upon receiving and learning said first digital data. This process can be repeated many times for said patient and physician or physicians. There is a denominator means for permitting assimilations of said first digital data into said second digital data. Having assigned certain codes or passwords or logins assigned and agreed upon by said people, this assimilation or these assimilations can be manually or automatically and repetitively used or performed with or without the involvement of said people.

The electronic or digital information also comprises a third digital data generated by a plurality of physician upon receiving and learning said first and second digital data. As above, this process can be repeated many times for said patient and physicians. Similarly, there is a denominator means for permitting assimilations of said first and second digital data into said third digital data. Having assigned certain codes or passwords or logins assigned and agreed upon by said people, this assimilation or these assimilations can be manually or automatically and repetitively used or performed with or without the involvement of said people.

For all above settings and circumstances, said denominator means for permitting availability of said data or any and certain or all portion of said data to a patient, physician, physicians or certain physicians. Therefore, said data can be shared and available by appropriate said people to appropriate patient and physicians in the appropriate and allowable circumstances.

Said denominator means include demographic information of a patient selected, happened, biological, or assigned to a patient such as, but not limited to, a unique identity of a patient such as, but not limited to, his or her names, date of birth, social security, DNA codes, finger prints and pattern of retina or voice and health data. Using said denominator, said people can transact and assisimilate said digital information and data.

A means for blocking or excluding a physician or physicians, at any or all time, from accessing said digital informaton and data is permitted to a patient or a physician by the present invention. The process of the means involves the deleting—temporary or permanently—a database of a physician or the databases of physicians by a patient. Therefore, a patient can deny authorization to access his or her data.

The present invention also provides a means for preventing non-party to the data of a patient. This is achieved by using many types of commercial encryption being used by commerce, government and military to protect vital data.

Never before in the history of mankind, said data are most efficiently, speedily and securely shared, perused and evaluated by appropriate patients and physicians yielding the most efficient system of management of the health-care and human resources. The physicians are the health-care providers and are effectively and optimally compensated for their works. physicians. In the present invention, based on said information or data and their uses and outcomes by a physician or physicians, health-care consumers, health-care buyers such as, but not limited to, companies, corporations, organizations and government who pay for the health-care services, some physicians are the determinators and/or payers of the above amounts of compensations or money to said physicians.

Although various preferred embodiments of this invention have been described, it will be appreciated by those skilled in the art that adaptations and variations may be made without departing from the spirit of the invention and the scope of the claims.

1. A system of electronic transactions effecting payments to physicians for the health-care services rendered by said physicians comprises:
a first digital data generated by a patient;
a second digital data generated by a physician;
a third digital data generated by a plurality of physicians;
a denominator means for permitting assimilations of said first digital data into said second digital data;
a denominator means for permitting assimilations of said first digital data into said third digital data;
a denominator means for permitting assimilations of second digital data into said third digital data;
a denominator means for permitting availability of said data to a patient;
a denominator means for permitting availability of said data to a physician;
a denominator means for permitting availability of said data to a plurality of physicians;
a means for excluding a physician from accessing said data;
a means for excluding a plurality of physicians from accessing said data;
a process of availing said data to said patient;
a process of availing said data to a plurality of physicians;
a process of assimilating said first digital data into said second digital data;
a process of assimilating said first digital data into said third digital data;
a process of assimilating said second digital data into said third digital data;
a process of effecting an exclusion of a physician from accessing said data; and
a process of effecting the exclusions of a plurality of physicians from accessing said data.

2. The system according to claim 1 wherein said denominator means for permitting assimilations comprises demographic information of a patient.

3. The demographic information according to claim 4 comprises a unique identity of a patient.

4. The system according to claim 1 wherein said denominator means for permitting assimilations comprises data on the health of a patient.

5. The system according to claim 1 wherein said denominator means for permitting availability comprises demographic information of a patient.

6. The demographic information according to claim 2 comprises a unique identity of a patient.

7. The system according to claim 1 wherein said means for excluding a physician from accessing said data comprises a deletion means for removing a physician's database

8. The system according to claim 1 wherein said means for excluding a plurality of physicians from accessing said data comprises a deletion means for removing individual physicians' databases.

9. The system according to claim 1 wherein said process of effecting an exclusion of a physician from accessing said data comprises a process of removing a physician's database.

10. The system according to claim 1 wherein said process of effecting the exclusions of a plurality of physicians from accessing said data comprises a process of removing individual physicians' databases.

11. A system of electronic transactions leading to payments to physicians or other health-care providers for health-care services rendered to the health-care consumers or patients by the health-care consumers or patients and/or health-care buyers wherein electronic information comprising digital data relating to health and health-care services are generated by individual health-care consumers or patients and individual physicians comprises:
a first digital data generated by a patient;
a second digital data generated by a physician;
a third digital data generated by a plurality of physicians;
a denominator means for permitting assimilations of said first digital data into said second digital data;
a denominator means for permitting assimilations of said first digital data into said third digital data;
a denominator means for permitting assimilations of second digital data into said third digital data;
a denominator means for permitting availability of said data to a patient;
a denominator means for permitting availability of said data to a physician;
a denominator means for permitting availability of said data to a plurality of physicians;
a means for excluding a physician from accessing said data;
a means for excluding a plurality of physicians from accessing said data;
a process of availing said data to said patient;
a process of availing said data to a plurality of physicians;
a process of assimilating said first digital data into said second digital data;
a process of assimilating said first digital data into said third digital data;
a process of assimilating said second digital data into said third digital data;
a process of effecting an exclusion of a physician from accessing said data; and
a process of effecting the exclusions of a plurality of physicians from accessing said data.

12. A system of electronic transactions leading to payments to physicians or other health-care providers for health-care services rendered to the health-care consumers or patients by health-care consumers or patients and/or health-care buyers wherein electronic information also known as digital data relating to health and health-care services are generated by individual health-care consumers or patients and individual physicians comprises:
a first digital data generated by a patient;
a second digital data generated by a physician;
a third digital data generated by a plurality of physicians;
a denominator means for permitting assimilations of said first digital data into said second digital data;
a denominator means for permitting assimilations of said first digital data into said third digital data;
a denominator means for permitting assimilations of second digital data into said third digital data;
a denominator means for permitting availability of said data to a patient;
a denominator means for permitting availability of said data to a physician;
a denominator means for permitting availability of said data to a plurality of physicians;
a means for excluding a physician from accessing said data;
a means for excluding a plurality of physicians from accessing said data;
a process of availing said data to said patient;
a process of availing said data to a plurality of physicians;
a process of assimilating said first digital data into said second digital data;
a process of assimilating said first digital data into said third digital data;
a process of assimilating said second digital data into said third digital data;
a process of effecting an exclusion of a physician from accessing said data;
a process of effecting the exclusions of a plurality of physicians from accessing said data;
an encryption means for encrypting a portion of said data;
a decryption means for decrypting the outcomes of the applications of said encryption means for encrypting a portion of said data;
a process of encrypting a portion of said data;
a process of encrypting a portion of a product of said data;
a process of decrypting an encrypted data; and
a process of decrypting an encrypted portion of a product of said data.
